(19) United States
(12) Patent Application Publication
(10) Pub. No.: US 2007/0216322 A1
(43) Pub. Date: Sep. 20, 2007

(54) Backlight unit for display device and driving circuit of the same

(76) Inventor: Pu-Jin Kim, Gumi-si (KR)

Correspondence Address: Song K. Jung;MCKENNA LONG & ALDRIDGE LLP, 1900 K. Street, N.W., Washington, DC, 20006, US

(21) Appl. No.: 11/644,984

(22) Filed: Dec. 26, 2006

(30) Foreign Application Priority Data
Mar. 15, 2006 (KR) 2006-0024085

(51) Int. Cl. H05B 39/00

(52) U.S. Cl. 315/312

(57) ABSTRACT

A backlight unit for a display device includes an alternating current (AC) power supply that connects to an AC generator to output a first AC voltage; at least one LED array driven by the first AC voltage and including a plurality of LEDs; and an impedance matching element connected in series with the AC power supply and the at least one LED array that controls current supplied to supplies power to the at least one LED array.

This application claims the benefit of Korean Patent Application No. 2006-0024085, filed on Mar. 15, 2006, which is hereby incorporated by reference for all purposes as if fully set forth herein.

### BACKGROUND OF THE INVENTION

1. Field of the Invention

The present invention relates to a backlight unit for a liquid crystal display (LCD) device and a driving circuit of the backlight unit, and more particularly, to a backlight unit including a plurality of light emitting diode (LED) arrays and a driving circuit controlling the backlight unit to provide a static current.

2. Discussion of the Related Art

Liquid crystal display (LCD) devices are widely used as a monitor for notebook computers and desktop computers and a television because of their high resolution, high contrast ratio, color rendering capability and superior performance for displaying moving images. An LCD device relies on the optical anisotropy and polarizing properties of liquid crystal to produce an image. A typical LCD device includes a liquid crystal display panel including two substrates and a liquid crystal layer between the two substrates. An electric field generated between the two substrates adjusts an alignment direction of liquid crystal molecules in the liquid crystal layer to produce differences in transmittance.

Because the liquid crystal display panel does not include an emissive element, a light source is required to view images on the liquid crystal display panel. Accordingly, a backlight unit having a light source is disposed under the liquid crystal display panel. The backlight unit for an LCD device may be classified as either a side light type or a direct type according to the position of the light source relative to the LCD panel. In a side light type backlight unit, light emitted from at least one side portion of the liquid crystal display panel is redirected by a light guide plate (LGP) to enter the liquid crystal display panel. In a direct type backlight unit, a plurality of light sources is disposed at a rear surface of the liquid crystal display panel so that light from the plurality of light sources directly enters the liquid crystal display panel.

A cold cathode fluorescent lamp (CCFL) and an external electrode fluorescent lamp (EEFL) have been used as a light source of a backlight unit for a liquid crystal display device. More recently, a light emitting diode (LED) has been used as a light source because the LED has excellent color reproducibility and brightness without using mercury (Hg). A backlight unit including one or more LEDs may be referred to as an LED backlight unit.

FIG. 1 is a schematic perspective view showing a liquid crystal display device including an LED backlight unit according to the related art. In FIG. 1, a liquid crystal display (LCD) device includes a liquid crystal display panel 10 and an LED backlight unit 20 under the liquid crystal display panel 10. The LED backlight unit 20 includes a plurality of printed circuit boards (PCBs) 22 each having a plurality of LEDs 24. The plurality of PCBs 22 is disposed in stripes at a rear surface of the liquid crystal display panel 10. The plurality of LEDs 24 may include red, green and blue LEDs that emit red, green and blue colored lights, respectively, and are arranged in a predetermined pattern. A white colored light may be obtained by mixing the red, green and blue colored lights emitted when the red, green and blue LEDs are turned on at the same time. To reduce power consumption, an LED array having a predetermined mixture of the red, green and blue LEDs is repeatedly arranged on each PCB 22 to produce a white colored light.

In addition, the LED array may be driven by a driving circuit. FIG. 2 is a driving circuit for an LED backlight unit according to the related art. In FIG. 2, an LED array 30 is disposed between a first terminal 32 and a second terminal 34, and a controller 50 is disposed between the input terminal 32 and the LED array 30. The LED array 30 includes at least one set of red, green and blue LEDs 38 connected to one another in series. A direct current (DC) voltage “Vin” is applied between the first terminal 32 and the second terminal 34 to provide driving power for the LED array 30, and the controller 50 adjusts the magnitude of the DC voltage “Vin” so that LED array emits light of a predetermined brightness of light.

In an LED backlight unit according to the related art, however, an individual driving circuit is required for each LED array 30. Accordingly, the LED backlight unit of the related art has disadvantages in production cost for the driving circuit and in utilization of installation space for the driving circuit. For example, in a large sized LCD device having a diagonal length over about 42 inches, several hundreds of LEDs may be used and a plurality of driving circuits may be required for the LED arrays 30 of the LED backlight unit. As a result, production cost and installation space increase, as the LCD device becomes more complex and thicker in profile to accommodate the backlight driving circuits.

### SUMMARY OF THE INVENTION

Accordingly, the present invention is directed to a backlight unit for a liquid crystal display device and a driving circuit of the backlight unit that substantially obviate one or more of the problems due to limitations and disadvantages of the related art.

An advantage of the present invention is to provide a backlight unit including at least one LED array and a driving circuit controlling the at least one LED array with a static current.

Another advantage of the present invention is to provide a backlight unit that supplies high quality, stable light using a reduced number of driving circuits.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a backlight unit for a display device includes: an alternating current (AC) power supply that connects to an AC generator to output a first AC voltage; at least one LED array driven by the first AC voltage and including a plurality of LEDs; and an impedance matching element connected in series with the AC power supply and the at least one LED array that controls current supplied to supplies power to the at least one LED array.

In another aspect of the present invention, a driving circuit for a backlight unit having at least one LED array includes: an AC power supply that outputs an AC voltage; and an impedance matching element connected to the AC power supply and controlling the at least one LED array with a static current.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic perspective view showing a liquid crystal display device including an LED backlight unit according to the related art.

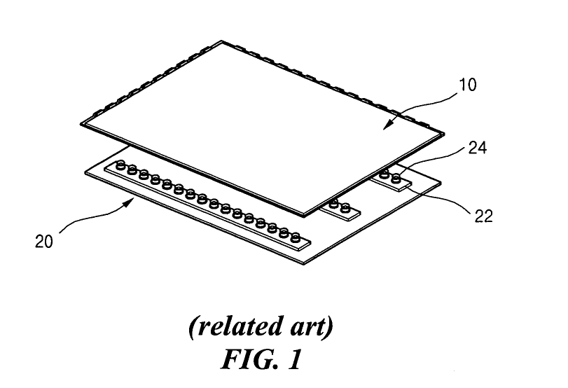

FIG. 2 is a driving circuit for an LED backlight unit according to the related art.

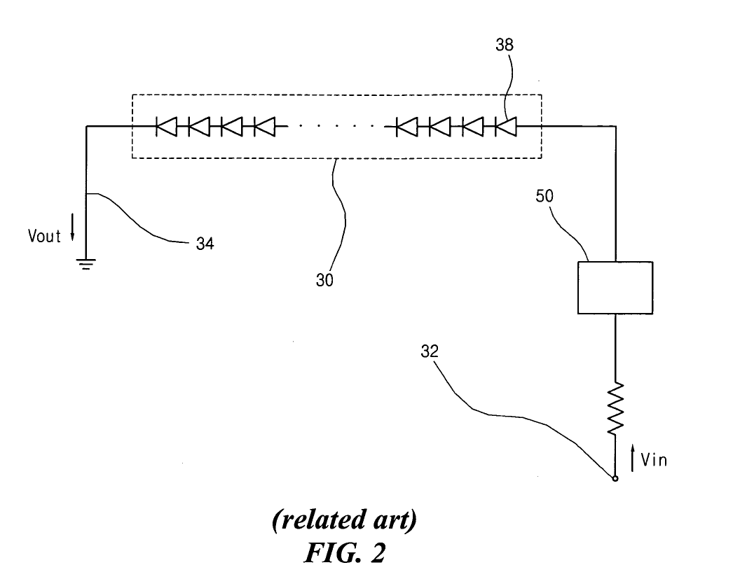

FIG. 3A is a schematic circuit diagram showing a backlight unit according to a first embodiment of the present invention.

FIG. 3B is a schematic circuit diagram showing a backlight unit according to a second embodiment of the present invention

FIG. 4A is a schematic circuit diagram showing a backlight unit according to a third embodiment of the present invention.

FIG. 4B is a schematic circuit diagram showing a backlight unit according to a fourth embodiment of the present invention.

### DETAILED DESCRIPTION OF THE ILLUSTRATED EMBODIMENTS

Reference will now be made in detail to embodiments of the present invention, an example of which are illustrated in the accompanying drawings. Wherever possible, the same reference numbers will be used throughout the drawings to refer to the same or like parts.

A backlight unit according to the present invention may include at least one LED array and a single driving circuit controls the at least one LED array with a static current. The at least one LED array is driven by an alternating current (AC) voltage and a current applied to the at least one LED array is controlled by an impedance matching element.

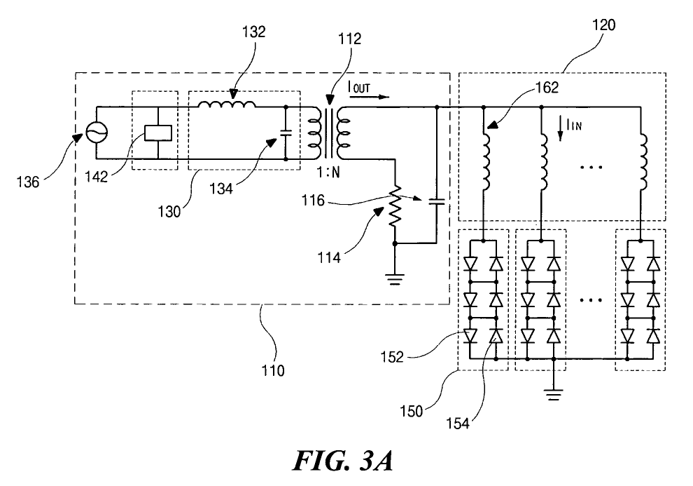

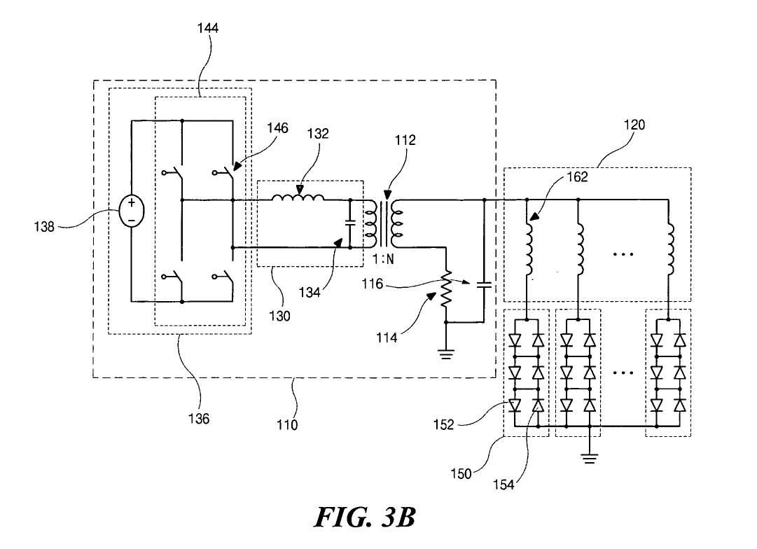

FIGS. 3A and 3B are schematic circuit diagrams showing a backlight unit according to first and second embodiments respectively, of the present invention.

In FIGS. 3A and 3B, a backlight unit includes a driving circuit that has an alternating current (AC) source 110 an impedance matching element 120, and at least one LED array 150. The AC power supply 110 outputs a first AC voltage to the at least one LED array 150 through an impedance matching element 120. The impedance matching element 120 may include a plurality of inductors 162 each connected in series to a respective one of the at least one LED arrays 150. As a result, the LED arrays 150 are connected to the AC power supply 110 in parallel through a respective one of the plurality of inductors 162.

Each LED array 150 includes a predetermined mixture of red, green and blue LEDs to display a white colored light. In addition, each LED array 150 includes a forward LED sub-array 152 and a reverse LED sub-array 154 connected in a parallel combination in series with the inductor 162 such that the at least one LED array 150 may be driven by an AC voltage. Because diodes of the forward LED sub-array 152 are connected in opposite polarity to the diodes of the reverse LED sub-array 154, the current flow direction in the forward LED sub-array 152 to generate light is opposite to a current flow direction in the reverse LED sub-array 154. Each of the forward and reverse LED sub-arrays 152 and 154 includes at least one red LED, at least one green LED and at least one blue LED connected to each other in series, and each is powered by the first AC voltage to display white colored light. Further, a node between two adjacent LEDs in the forward LED sub-array 152 may be connected to a node between two adjacent LEDs in the reverse LED sub-array 154. As described above, the inductor 162 as the matching element is connected in series to each combination of the forward and reverse LED arrays 152 and 154.

The AC power supply 110 outputs the first AC voltage as a driving voltage. For example, as in the first embodiment illustrated in FIG. 3A, the AC power supply 110 may include an AC voltage generator 136, a controller or regulator 142, a low pass filter (LPF) 130, a transformer 112, a resistor 114 and an auxiliary capacitor 116. The transformer 112 steps up a second AC voltage input applied to the primary according to a turns ratio of 1:N (where N≧2) of the transformer so that the first AC voltage is output from the transformer secondary. In addition, the resistor 114 and the inductor 162 are connected in series to the secondary winding of the transformer 112 thereby constituting a series RL (resistor and inductor) circuit. As a result, an input current “Iin” input into the at least one LED array 150 is filtered from an output current “Iout” from the AC power supply 110 by the impedance “ωL” of the inductor 162.

The driving circuit of an LED backlight unit according to the first embodiment of the present invention supplies the at least one LED array 150 with a constant or static current by adjusting the impedance of the inductor 162. Moreover, the driving circuit may supply equal currents to each of the at least one LED array 150.

The second AC voltage is filtered by the low pass filter 130 to generate an output waveform having a predetermined frequency band. The second AC voltage is output from the AC voltage generator 136 and the low pass filter 130 is connected between the AC voltage generator 136 and the primary of the transformer 112. In addition, the low pass filter 130 may include a filter inductor 132 and a filter capacitor 134 that are connected to the AC voltage generator 136 in series and in parallel, respectively. Furthermore, the controller 142 that regulates and controls a power of the second AC voltage is connected between the AC voltage generator 136 and the low pass filter 130. As a result, high frequency noise of the second AC voltage outputted from the AC voltage generator 136 through the controller 142 is removed by the low pass filter 130. The second AC voltage having the predetermined frequency band is supplied to the primary of the transformer 112 and the potential of the AC voltage is stepped up by the transformer 112 and output from the secondary of the transformer 112 as the first AC voltage. The at least one LED array 150 are supplied with a constant or static current using the impedance of the inductor 162 and the first AC voltage to supply the LED arrays 150. Therefore, a current input to each of the at least one LED array 150 may be adjusted to a uniform value.

In the second embodiment of FIG. 3B, the AC power supply 110 may include a DC voltage generator 138, a DC/AC inverter 144, a low pass filter (LPF) 130, a transformer 112, a resistor 114 and an auxiliary capacitor 116. The DC voltage generator 138 outputs a DC voltage, and the DC/AC inverter 144 inverts the DC voltage into a second AC voltage supplied to a primary of the transformer 112. The DC/AC inverter 144 may include a plurality of field effect transistors (FETs) 146 connected in a full wave bridge configuration. By controlling the FETs, the full bridge type DC/AC inverter 144 may adjust and regulate a power of the second AC voltage. As a result, the DC voltage generator 138 and the DC/AC inverter 144 perform the functions provided by the AC voltage generator 136 and the controller 142 of FIG. 3A of supplying a second AC voltage.

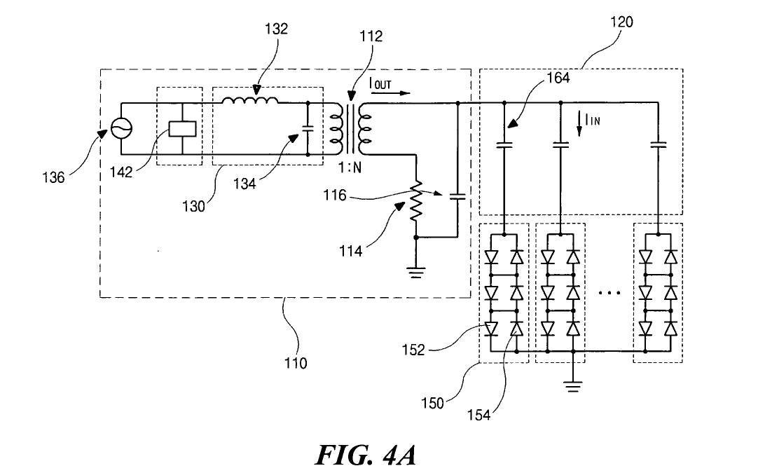

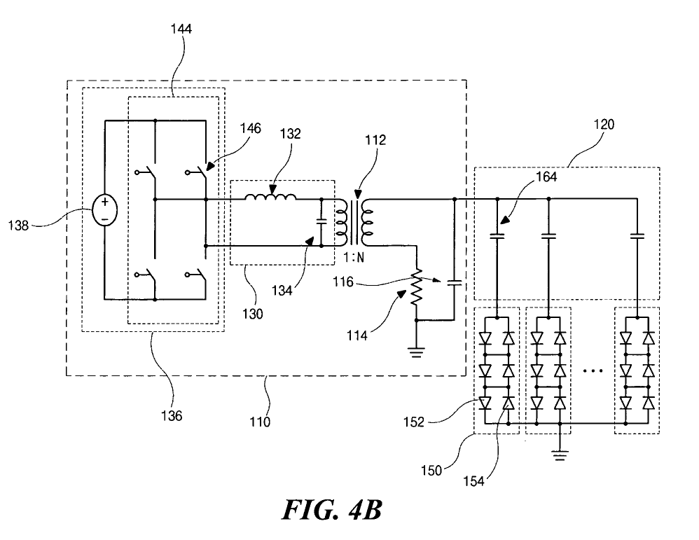

FIGS. 4A and 4B are schematic circuit diagrams showing a backlight unit according to third and fourth embodiments, respectively, of the present invention.

In FIGS. 4A and 4B, a backlight unit includes a driving circuit that has an AC power supply 110, an impedance matching element 120, and at least one LED array 150. The AC power supply 110 outputs a first AC voltage to the plurality of LED arrays 150 through the impedance matching element 120. The impedance matching element 120 may include a plurality of capacitors 164 each connected to the at least one LED array 150 in series. As a result, the plurality of LED arrays 150 are connected to the AC power supply 110 in parallel through the plurality of capacitors 164.

Each LED array 150 includes a predetermined mixture of red, green and blue LEDs to display a white colored light. In addition, each LED array 150 includes a forward LED sub-array 152 and a reverse LED sub-array 154 connected in a parallel combination in series with the capacitor 164 such that the at least one LED array 150 may be driven by an AC voltage. Each of the forward and reverse LED sub-arrays 152 and 154 includes at least one red LED, at least one green LED and at least one blue LED connected to each other in series, and displays white colored light by the first AC voltage. Further, a node between two adjacent LEDs in the forward LED sub-array 152 may be connected to a node between two adjacent LEDs in the reverse LED sub-array 154. The capacitor 164 as the matching element is connected in series to each of the forward and reverse LED arrays 152 and 154.

The AC power supply 110 outputs the first AC voltage as a driving voltage. For example, as in the third embodiment illustrated in FIG. 4A, the AC power supply 110 may include an AC voltage generator 136, a controller 142, a low pass filter (LPF) 130, a transformer 112, a resistor 114 and an auxiliary capacitor 116. The transformer 112 steps up a second AC voltage input applied to the primary according to a turns ratio of 1:N (N>1) of the transformer so that the first AC voltage is output from the transformer secondary. In addition, the resistor 114 and the capacitor 162 are connected in series to the secondary winding of the transformer 112 thereby constituting a series RC (resistor and capacitor) circuit. As a result, an input current “Iin” input into the at least one LED array 150 is filtered from an output current “Iout” from the AC power supply 110 by the impedance “1/ωC” of the capacitor 164.

The driving circuit of an LED backlight unit according to the third embodiment of the present invention supplies each of the at least one LED array 150 with a constant or static current set by adjusting the impedance of the capacitor 164. Moreover, the single driving circuit may supply an equal current to each of the at least one LED array 150.

The second AC voltage is filtered by the low pass filter 130 to generate an output waveform have a predetermined frequency band. The second AC voltage is output from the AC voltage generator 136 and the low pass filter 130 is connected between the AC voltage generator 136 and the primary of the transformer 112. In addition, the low pass filter 130 may include a filter inductor 132 and a filter capacitor 134 that are connected to the AC voltage generator 136 in series and in parallel, respectively. Furthermore, the controller 142 regulates and controls a power of the second AC voltage is connected between the AC voltage generator 136 and the low pass filter 130. As a result, high frequency noise of the second AC voltage output from the AC voltage generator 136 through the controller 142 is removed by the low pass filter 130. The second AC voltage having the predetermined frequency band is supplied to the primary of the transformer 112 and stepped up by the transformer 112 and output from the secondary of the transformer 112 as the first AC voltage. The at least one LED array 150 is supplied with a constant or static current using the impedance of the capacitor 164 and the first AC voltage to supply the LED arrays 150. Therefore, a current input to each of the at least one LED array 150 may be adjusted to a uniform value.

In the second embodiment illustrated in FIG. 4B, the AC power supply 110 may include a DC voltage generator 138, a DC/AC inverter 144, a low pass filter (LPF) 130, a transformer 112, a resistor 114 and an auxiliary capacitor 116. The DC voltage generator 138 outputs a DC voltage, and the DC/AC inverter 144 inverts the DC voltage into a second AC voltage supplied to a primary of the transformer 112. The DC/AC inverter 144 may include a plurality of field effect transistors (FETs) 146 connected in a full wave bridge configuration. By controlling the FETs, the full bridge type DC/AC inverter 144 may adjust and regulate a power of the second AC voltage. As a result, the DC voltage generator 138 and the DC/AC inverter 144 perform the functions of the AC voltage generator 136 and the controller 142 of FIG. 4A of supplying a second AC voltage.

In embodiments of the present invention, because a single driving circuit of a backlight unit controls a plurality of LED arrays with a constant current, a number of driving circuits of a backlight unit is reduced. Accordingly, fabrication cost for an LCD device may be reduced and an LCD device may be made more compact.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A backlight unit for a display device, comprising:
an alternating current (AC) power supply that outputs a first AC voltage;
at least one LED array driven by the first AC voltage and including a plurality of LEDs; and
an impedance matching element connected in series with the AC power supply and the at least one LED array that controls current to supply power to the at least one LED array.

2. The backlight unit according to claim 1, wherein the at least one LED array includes a forward LED sub-array and a reverse LED sub-array connected in a parallel combination, the parallel combination connected in series to the impedance matching element wherein a current flow to operate the forward LED sub-array is in the opposite direction to the current flow to operate the reverse LED sub-array.

3. The backlight unit according to claim 2, wherein a node between adjacent LEDs in the forward LED sub-array is connected to a node between two adjacent LEDs in the reverse LED sub-array.

4. The backlight unit according to claim 2, wherein each of the forward and reverse LED sub-arrays includes at least one red LED, at least one green LED and at least one blue LED.

5. The backlight unit according to claim 1, wherein the impedance matching element includes at least one inductor.

6. The backlight unit according to claim 5, wherein the AC power supply includes a resistor connected in series with the at least one inductor.

7. The backlight unit according to claim 6, wherein an input current input into each of the at least one LED array is controlled by the impedance of the at least one inductor.

8. The backlight unit according to claim 1, wherein the impedance matching element includes at least one capacitor.

9. The backlight unit according to claim 8, wherein the AC power supply includes a resistor connected in series with the at least one capacitor.

10. The backlight unit according to claim 9, wherein an input current input into each of the at least one LED array is controlled by an impedance of the at least one capacitor.

11. The backlight unit according to claim 1, wherein the AC power supply includes a transformer having a primary and a secondary, and wherein a second AC voltage is input into the transformer primary and the first AC voltage is output from the transformer secondary.

12. The backlight unit according to claim 11, wherein the AC power supply further includes:
an AC voltage generator that supplies the second AC voltage; and
a low pass filter connected between the AC voltage generator and the transformer primary.

13. The backlight unit according to claim 12, wherein the low pass filter comprises:
a filter inductor connected in series between the AC voltage generator and the transformer primary; and
a filter capacitor connected in parallel with the AC voltage generator and the transformer primary.

14. The backlight unit according to claim 12, wherein the AC power supply further comprises a controller connected between the AC voltage generator and the low pass filter that adjusts the power of the second AC voltage.

15. The backlight unit according to claim 11, wherein the AC power supply further includes:
a DC voltage generator that outputs a DC voltage;
a DC/AC inverter connected between the DC voltage generator and the transformer primary that outputs the second AC voltage.

16. The backlight unit according to claim 15, wherein the DC/AC inverter includes a plurality of field effect transistors connected in a full-wave bridge configuration, and wherein the DC/AC inverter inverts the DC voltage into the second AC voltage and controls a power of the second AC voltage.

17. A driving circuit for a backlight unit having at least one LED array, comprising:
an AC power supply that outputs an AC voltage; and
an impedance matching element connected to the AC power supply and controlling the at least one LED array using a statically controlled current.
